(19) United States
(12) Patent Application Publication
(10) Pub. No.: US 2005/0280508 A1
(43) Pub. Date: Dec. 22, 2005

(54) System and method for controlling range of successful interrogation by RFID interrogation device

(76) Inventors: Jim Mravca, Sunnyvale, CA (US); Daniel Dobkin, Sunnyvale, CA (US)

Correspondence Address: DORSEY & WHITNEY LLP, 555 CALIFORNIA STREET, SUITE 1000, SUITE 1000, SAN FRANCISCO, CA, 94104, US

(21) Appl. No.: 11/067,548

(22) Filed: Feb. 24, 2005

Related U.S. Application Data
(60) Provisional application No. 60/547,495, filed on Feb. 24, 2004.

(51) Int. Cl. H04Q 5/22

(52) U.S. Cl. 340/10.2; 340/572.1; 340/10.3

(57) ABSTRACT

The present invention is directed to control an range of successful interrogation by an RFID reader so that tags located in a specific physical area are likely to be successfully interrogated by the reader while the chance of the reader reading tags in other locations are minimized. In one embodiment of the present invention, a plurality of delineation RFID tags with known unique identifying numbers are placed in an areas of interest or wanted region, and the reader is characterized to determine an optimal setting for at least one transmission parameter based on responses from the delineation RFID tags and a predetermined figure of merit.

### CROSS REFERENCE TO RELATED APPLICATIONS

The present application claims the benefit of and priority to U.S. Provisional Patent Application No. 60/547,495 filed on Feb. 24, 2004, the entire disclosure of which is hereby incorporated by reference in its entirety.

### FIELD OF THE INVENTION

The present invention relates in general to interrogation of radio-frequency identification (RFID) transponders, and particularly to a method and system for interrogating ‘passive’ RFID transponders while controlling a range of successful interrogation.

### BACKGROUND OF THE INVENTION

RFID technologies are widely used for automatic identification. A basic RFID system includes an RFID tag or transponder carrying identification data and an RFID interrogator or reader that reads and/or writes the identification data. An RFID tag typically includes a microchip for data storage and processing, and a coupling element, such as an antenna coil, for communication. Tags may be classified as active or passive. Active tags have built-in power sources while passive tags are powered by radio waves received from the reader and thus cannot initiate any communications.

An RFID reader operates by writing data into the tags or interrogating tags for their data through a radio-frequency (RF) interface. During interrogation, the reader forms and transmits RF waves, which are used by tags to generate response data according to information stored therein. The reader also detects reflected or backscattered signals from the tags at the same frequency, or, in the case of a chirped interrogation waveform, at a slightly different frequency. The reader typically detects the reflected or backscattered signal by mixing this signal with a local oscillator signal. This detection mechanism is known as homodyne architecture.

In many applications of RFID techniques, such as automated vehicle identification and/or fare collection, or automated inventory of trucks entering loading docks, it is desirable that a particular interrogating device identifies only RFID tags located in a specific physical region. For example, in a warehouse or facility with multiple adjacent loading docks each accepting one vehicle at a time, it is desirable that the interrogating device or devices associated with a dock detect only RFID tags within the vehicle parked at or passing through that dock and not those of its neighbors. Similarly, in the case of automated vehicle identification which controls a tollgate or other passage restriction, it is desirable that a given tag reader sense only tags on vehicles in its assigned lane and not those of its neighbors.

Prior art solutions to this problem include the construction of physical barriers between separate regions in an attempt to prevent propagation of RF signals between the regions. Such barriers are expensive and inconvenient, as they must be either strongly absorbing or reflecting, and sufficiently large relative to the wavelength of the RF signals in question to minimize diffractive bypass of the obstacle.

Another approach, disclosed in U.S. Pat. No. 6,107,910, is to use a high-rate pseudorandom sequence to phase-modulate the transmitted signal, and convolve received signals with the sequence. By appropriate choice of the autocorrelation properties of the sequence employed, a null in the correlation can be created at a particular propagation delay, and used to reject signals at a certain distance, such as an adjacent lane or dock. However, this scheme suffers from the added complexity of a high-rate modulation imposed on the transmitter, and inflexibility in the placement of the rejected region relative to the accepted region.

A further approach, discussed in U.S. Pat. No. 6,097,301, employs control of the transmitted power to interrogate only the nearest RFID tag. This technique, however, is only applicable in situations where one tag will normally be close to the interrogation device with all other tags being far away. In many other applications, more than one tag may be equally or near equally close to the interrogation device, so that it is not possible to interrogate a just a single tag by ramping the transmitter power until a single tag is detected.

What is needed, therefore, is a flexible means of controlling the physical area interrogated by a given interrogation unit, such that all tags within the wanted area can be successfully read, while few or no tags in other areas are inadvertently interrogated.

### SUMMARY OF THE INVENTION

The present invention is directed to controlling a range of successful interrogation by an RFID reader so that tags located in a specific physical area are likely to be successfully interrogated by the reader while the chance of the reader reading tags in other locations are minimized. In one embodiment of the present invention, a plurality of delineation RFID tags with known unique identifying numbers are placed in an areas of interest or wanted region, and the reader is characterized to determine an optimal setting for at least one transmission parameter based on responses from the delineation RFID tags and a predetermined figure of merit.

More specifically, in some embodiments a system is provided for reading an RFID tag in a defined region while reducing the possibility of reading other RFID tags outside the region, comprising an RFID reader at a fixed location in or near the region, the RFID reader capable of adjusting at least one associated transmission parameter. A plurality of delineation RFID tags each having a known and unique identification are placed at specified locations in the region, and the at least one transmission parameter associated with the reader is set according to responses from the delineation RFID tags to interrogation signals from the RFID reader and a predetermined figure of merit.

In another aspect, a method for controlling a range of successful interrogation by an RFID reader associated with at least one adjustable transmission parameter, is provided comprising placing a plurality of delineation RFID tags at specified locations in a wanted region. For each of a plurality of trial parameter settings for the at least one transmission parameter, an attempt to interrogate the plurality of delineation RFID tags using the RFID reader is made and responses from the delineation RFID tags are recorded. An optimal transmission parameter setting is determined for the reader based on the a predetermined figure of merit calculated using the responses from the delineation RFID tags at each of the plurality of trial parameter settings and a pre-determined criteria, and at least one transmission parameter is set associated with the RFID reader according to the optimal transmission parameter setting.

### BRIEF DESCRIPTION OF THE DRAWINGS

Other aspects and advantages of the present invention will become apparent upon reading the detailed description of the invention and the appended claims provided, below, and upon reference to the drawings, in which:

FIG. 1 is a block diagram of a system for controlling a range of successful interrogation by an RFID reader according to one embodiment of the present invention;

FIG. 2 is a block diagram of an RFID reader according to one embodiment of the present invention;

FIG. 3A-3F are diagrams illustrating variations of a range of successful interrogation by an RFID reader when transmitted power from the RFID reader is varied;

FIG. 4 is a block diagram of a system for controlling a range of successful interrogation by an RFID reader according to an alternative embodiment of the present invention;

FIG. 5 is a block diagram of a system for controlling a range of successful interrogation by an RFID reader according to yet another alternative embodiment of the present invention;

FIGS. 6A and 6B are flowcharts illustrating a method for controlling a range of successful interrogation by an RFID reader according to one embodiment of the present invention;

FIGS. 7-9 are diagrams each illustrating an overlaps between a range of successful interrogation and a wanted range according to an embodiment of the present invention.

FIG. 10 is a block diagram of a system for controlling a range of successful interrogation by an RFID reader wherein additional receiving units are used in addition to, or in place of, delineation tags to provide better overlap between the range of successful interrogation and the wanted region, according to yet another embodiment of the present invention.

### DETAILED DESCRIPTION OF THE INVENTION

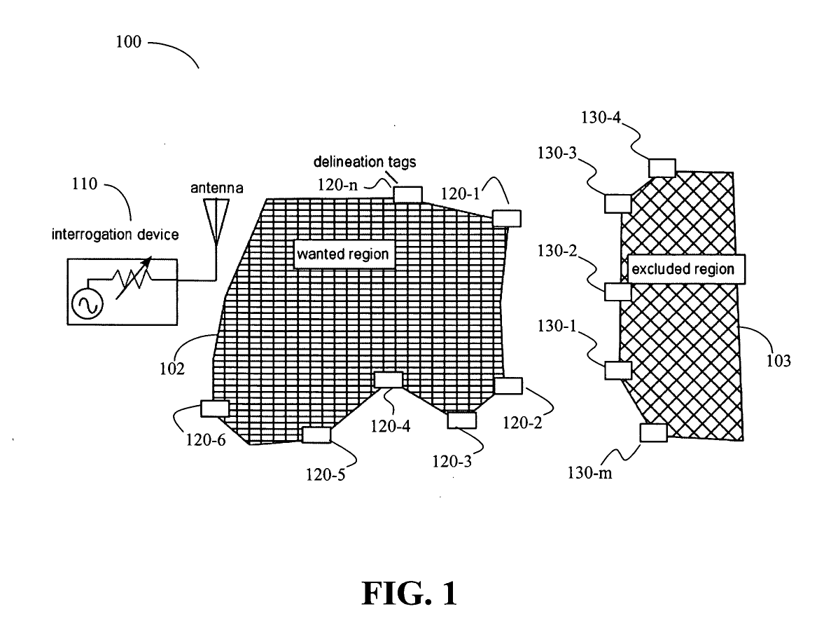

FIG. 1 illustrates a system 100 for controlling a range of successful interrogation by an RFID reader according to one embodiment of the present invention. As shown in FIG. 1, system 100 generally comprises an RFID reader 110 and a plurality of delineation RFID tags 120 placed at specified locations in a region of interest or wanted region 102. The wanted region 102 represents a region for intentional RFID interrogation. For example, in the situation of a tollgate, the wanted region 102 can be an area in front of the tollgate for cars to pass through while their toll meter is being read by an RFID reader installed at the tollgate. The plurality of delineation RFID tags 120 includes RFID tags 120-1, 120-2, . . . , and 120-n, where n is a positive integer greater than 1. Each delineation RFID tag 120 can be a conventional RFID tag having a known and unique identification number. The delineation RFID tags 120 can be placed along the boundary of wanted region 102, as shown in FIG. 1. They may also be staged through out wanted region 102. The delineation RFID tags 120 are used to characterize reader 110 so that reader 110 is likely to successfully read only those RFID tags that are located in or near wanted region 102. In other words, the delineation RFID tags 120 are used to characterize reader 110 so that wanted region 102 overlaps substantially with the range of successful interrogation by reader 110.

In addition to the delineation RFID tags, system 100 may also comprise a plurality of anti-delineation RFID tags 130 placed at specified locations in or around an excluded region 103. Excluded region 103 represents a region an RFID tag located wherein should not be inadvertently read by reader 110. In the example of reader 110 being installed at a tollgate, the excluded region 103 can be an area or areas in front of neighboring tollgate(s). As shown in FIG. 1, the plurality of anti-delineation RFID tags 130 include RFID tags 130-1, 130-2, . . . , and 130-m, where m is a positive integer greater than 1. Each anti-delineation RFID tag 130 can be a conventional RFID tag having a known and unique identification number that are different from the identification number in any of the delineation RFID tags 120. The anti-delineation RFID tags 130 can be placed along a side of the boundary of excluded region 103 that faces the wanted region 102, as shown in FIG. 1. They may also be staged throughout excluded region 103. The anti-delineation RFID tags 130 can be used to further characterize reader 110 so that reader 110 is unlikely to read RFID tags that are located in or near excluded region 103.

Although, for ease of illustration, FIG. 1 shows that regions 102 and 103 are constrained in two dimensions, the present invention also includes situations where regions 102 and/or 103 are bounded in three-dimensions.

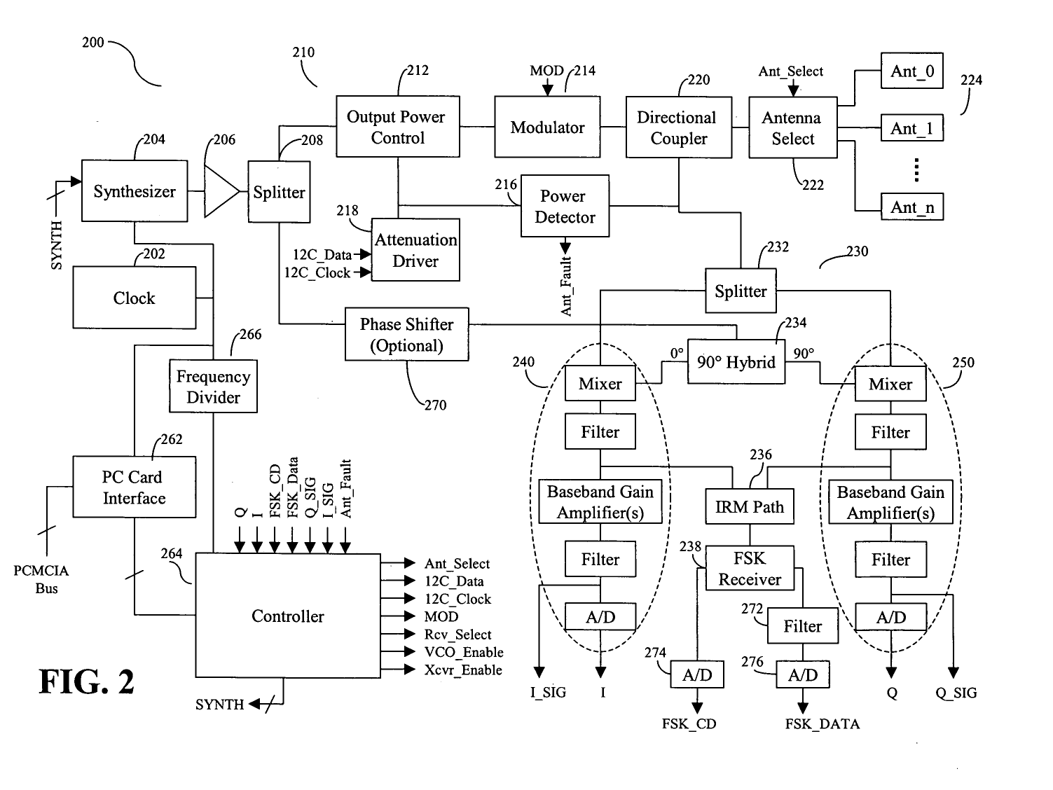

Reader 110 can be a conventional RFID reader having at least one transmission parameter that can be adjusted to limit its range of successful interrogation. In one embodiment of the present invention, the at least one transmission parameter can be adjusted to control the transmitted power from the reader, or the angular distribution of the transmitted power, or both. The at least one transmission parameter may also include a selection of one of a plurality of antennas for transmitting the interrogation signal from the reader when the reader is associated with more than one antennas. As an example, FIG. 2 illustrates an RFID reader 200 that can be used as reader 110 according to an embodiment of the present invention. As shown in FIG. 2, reader 200 includes a crystal oscillator 202 configured to generate a clock signal, and a frequency synthesizer 204 configured to generate a continuous wave (CW) signal referencing the clock signal. Reader 200 further includes a local oscillator (LO) buffer amplifier 206 coupled to synthesizer 204 and configured to amplify the CW signal. LO buffer amplifier 206 also protects the synthesizer from disturbances created from other parts of reader 200.

Reader 200 further includes a transmit (TX) chain 210 configured to form and transmit a transmit signal for interrogating a tag, and a receive (RX) chain 230 configured to receive the reflected or backscattered RF signal from the tag, and to generate a plurality of output signals from the RF signal. Transmit chain 210 includes an output power control module 212, a modulator 214, a power detector 216 and an attenuation driver 218. Receive chain 230 includes a splitter 232, a 90° hybrid 234, an I-branch 240, a Q-branch 250, an IRM path 236, an FSK receiver 238, a filter 272, analog to digital (A/D) converters 274 and 276, and an optional phase shifter 270.

Reader 200 further includes a splitter 208 coupled between LO buffer amplifier 206 and transmit/receive chains 210 and 230 and configured to split the CW signal from LO buffer amplifier 206 into a TX CW signal for the Transmit chain and a RX LO signal for the Receive chain. When more than one antenna can be used by reader 200, reader 200 may also include an antenna select module 222 configured to select one of a plurality of antenna 224 for broadcasting the transmit signal or receiving the RF signal from the tag. Reader 200 further includes a directional coupler 220 coupled between antenna select module 222 and transmit/receive chains 210 and 230. Directional coupler 220 is configured to pass the transmit signal from the transmit chain 210 to at least one antenna through antenna select module 222 and to couple the RF signals received by the antenna to the receive chain 230.

Reader 200 further includes a controller 264 configured to control the operation of various components of reader 200 by processing a plurality of input signals from the various components and producing a plurality of output signals that are used by respective ones of the components. A conventional commercially available controller, after being programmed according to an RFID standard, can be used as controller 264.

In one embodiment of the present invention, a host computer system can be used to operate reader 200 and characterize reader 200 according to characterization methods discussed below. Communication between reader 200 and the host computer is facilitated by a PC interface 262 in reader 200. FIG. 2B is a block diagram of a computer system 280 that can be used to operate and characterize reader 200. As shown in FIG. 2B, computer system 280 is a conventional computer system including a central processing unit (CPU) 282, a memory unit 284, a plurality of data import/output (I/O) ports 286, a user interface 288, and a display device 290. CPU 282, memory unit 284, I/O ports 286, user interface 288, and display device 290 are interconnected via a bus 292. Reader 200 can be coupled to host computer 200 through one of the 1/O ports 286. Memory 284 stores therein program instructions that when executed by CPU 282 causes host computer 280 to perform the characterization methods for characterizing reader 200, as discussed below. Memory 284 may also include a database storing therein data associated with the characterization methods, as discussed below.

For the sake of clarity, parts of reader 200 that are either conventional or otherwise unrelated to the present invention are not discussed in detail. More detailed description of one embodiment of reader 200 can be found in co-pending U.S. patent application Attorney Docket Number 463438-372 (33889/US/3) entitled MULTIPROTOCOL RFID READER, which disclosure is incorporated herein by reference in its entirety. Although reader 200 is used herein for illustration purposes, the invention is not limited to using reader 200 as the RFID reader 110 in system 100. Any interrogation device capable of adjusting its range of successful interrogation can be used as reader 110.

As discussed above, in reader 200, a signal generated by synthesizer 204 is employed to simultaneously provide the TX CW signal for the transmit chain and the RX LO signal for the receive chain. The TX CW signal is used to form the interrogation signal to be transmitted to one or more passive RFID tags, while the RX LO signal is used as a local oscillator signal to achieve homodyne detection of the backscattered signals from the tags. Thus, the transmitted power of the reader, i.e., the power in the interrogation signal, can be independently adjusted without affecting the operation of the receive chain by the employment of an output power control device placed in the transmit chain. In one embodiment of the present invention, the output power control device comprises a conventional variable attenuator in output control module 212.

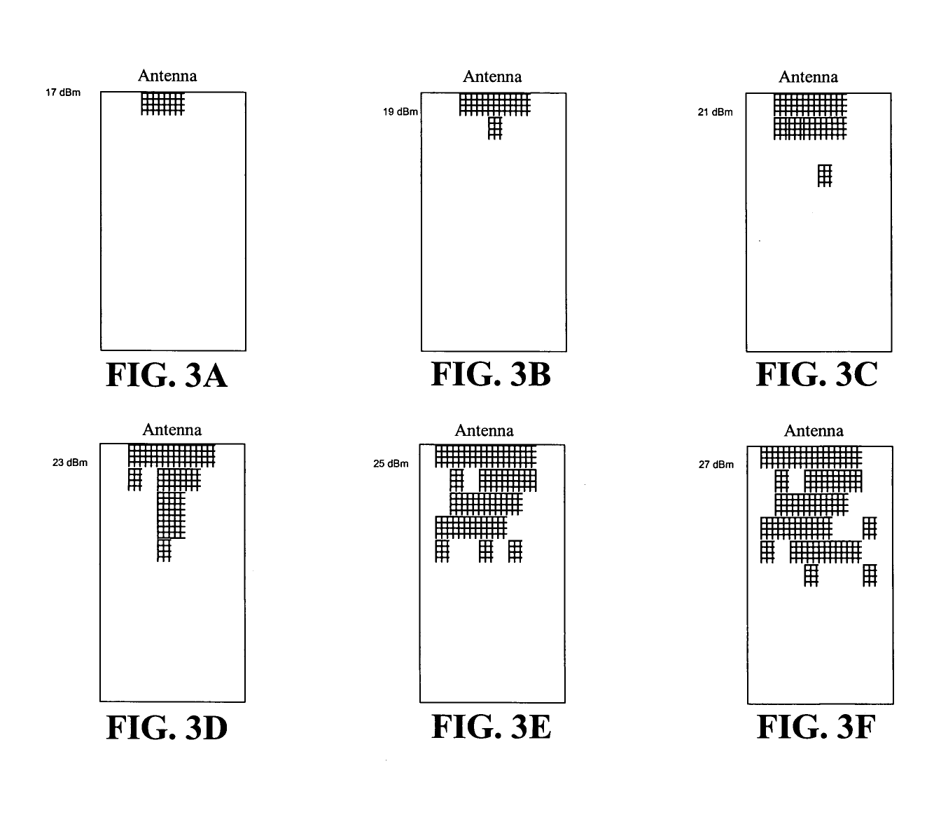

FIGS. 3A-3F illustrate responses of a plurality of RFID tags staged in a rectangular array in front of an antenna for transmitting interrogation signals from an RFID reader while the output power of the RFID reader is ramped from 17 dBm to 27 dBm. The shaded area in each rectangle represents a range of successful interrogation for a particular transmitted power setting. In other words, the RFID tags located in the shaded area have successfully responded to the interrogation signal transmitted from the antenna. When the transmitted power from the RFID reader is ramped, the range of successful interrogation also increases to cover a larger area in the rectangle 300. Since the RFID tags in the shaded areas are successfully interrogated by the RFID reader while the RFID tags outside the shaded areas are not, for each transmitted power setting, the RFID tags located at the edge of the shaded area are considered to be at or slightly above a threshold for successful interrogation by the RFID reader. Whether an RFID tag is at or slightly above the threshold for successful interrogation can be determined by either increasing the transmitted power by a small increment (e.g., 2 dBm) and check if the reader is able to read the RFID tag which the read could not read before the change or by decreasing the transmitted power by a small decrement (e.g., 2 dBm) and check if the reader is no longer able to read the RFID tag which the read could successfully read; before the change.

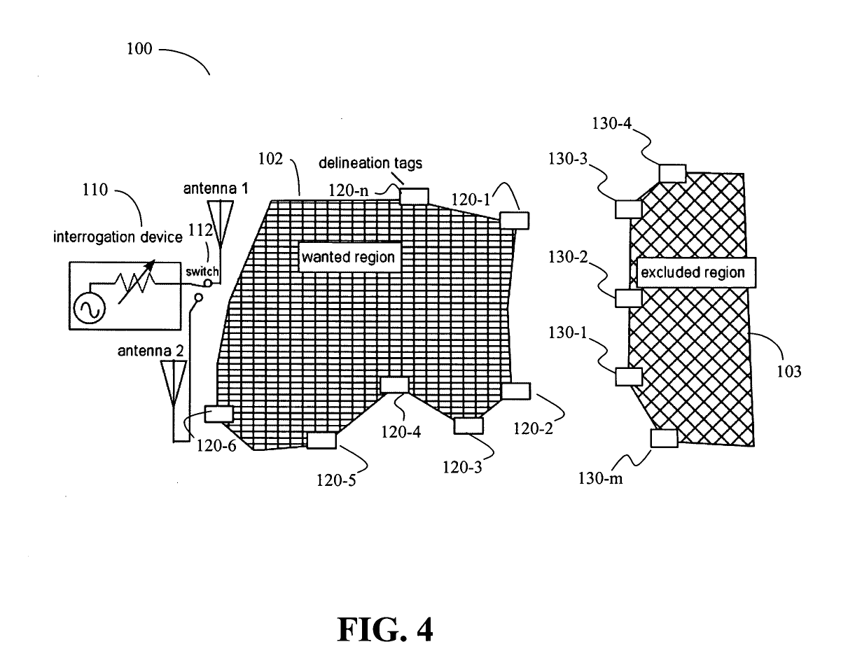

In addition to the transmitted power, the spatial distribution of the transmitted radiation from reader 110 can also be adjusted. In one embodiment of the present invention, as shown in FIG. 4, a plurality of differently oriented and/or separately located antennas, such as antenna 1 and antenna 2 in FIG. 3, are provided and reader 200 can be operated to adjust its coverage by switching among these antennas using the antenna select module or an external switch 112.

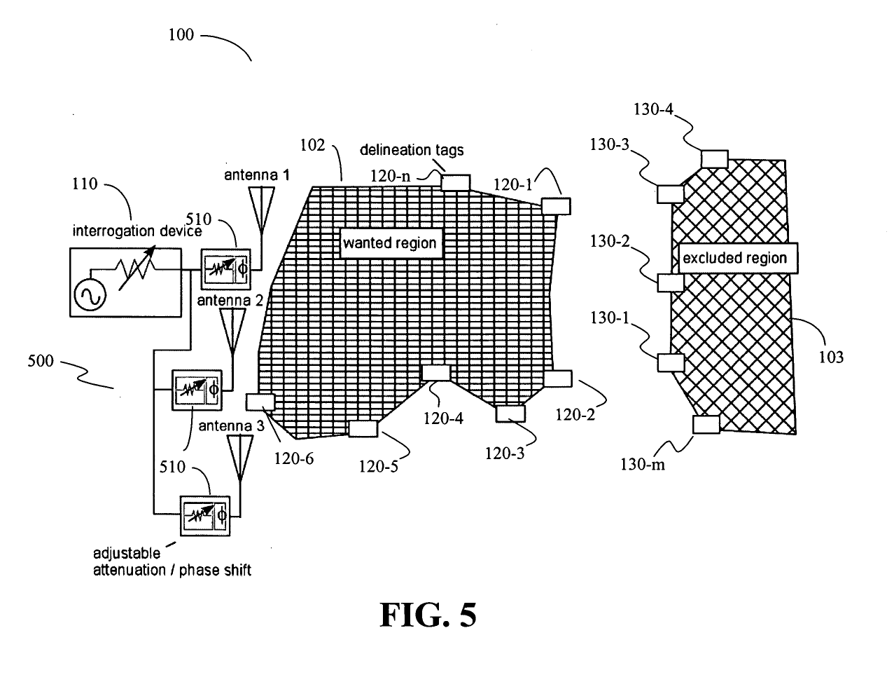

In another embodiment, as shown in FIG. 5, reader 200 can be coupled to an adaptive phased array 500 comprising two or more antennas, such as antenna 1, antenna 2, and antenna 3, that are held in adjustable phase and amplitude relationships with each other such that the transmitted signal is the sum of the radiated field from each antenna. The antennas in the phased array 500 may also be configured to transmit differently polarized signals to reduce interferences among them. In FIG. 5, each antenna in the phased array 500 is coupled to reader 200 through an adjustable attenuator and phase shifter 510 to allow phase and amplitude adjustment of the analog signal transmitted from each antenna. In one embodiment of the present invention, each adjustable attenuator and phase shifter 510 is coupled to host computer 280 via a different one of the I/O ports 286. So, the adjustments can be done according to a pre-selected algorithm by host computer 280, as discussed below. The directivity and orientation of each antenna in phased array 500 can also be adaptively varied under automated control. Furthermore, digitally-controlled radios could be employed in which phase and amplitude controls for the transmit signal from each antenna are accomplished by an analog quadrature modulator, enabling the connections to remote antennas from the reader 200 to be made using low-frequency baseband signals. The phase adjustments could be continuous, or they could be implemented using well-known fixed phase shifting networks, such that a finite selection of parameter settings for phased array 500 is available.

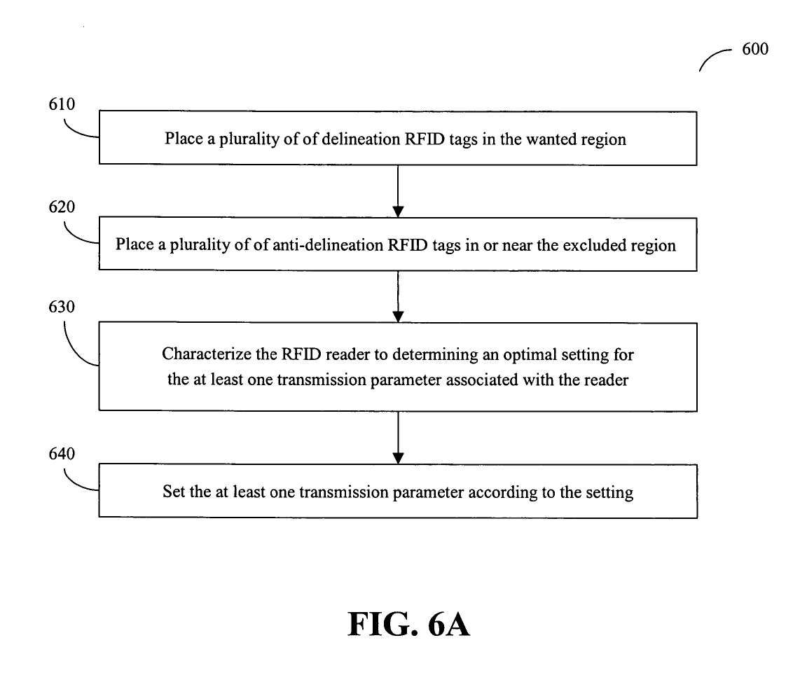

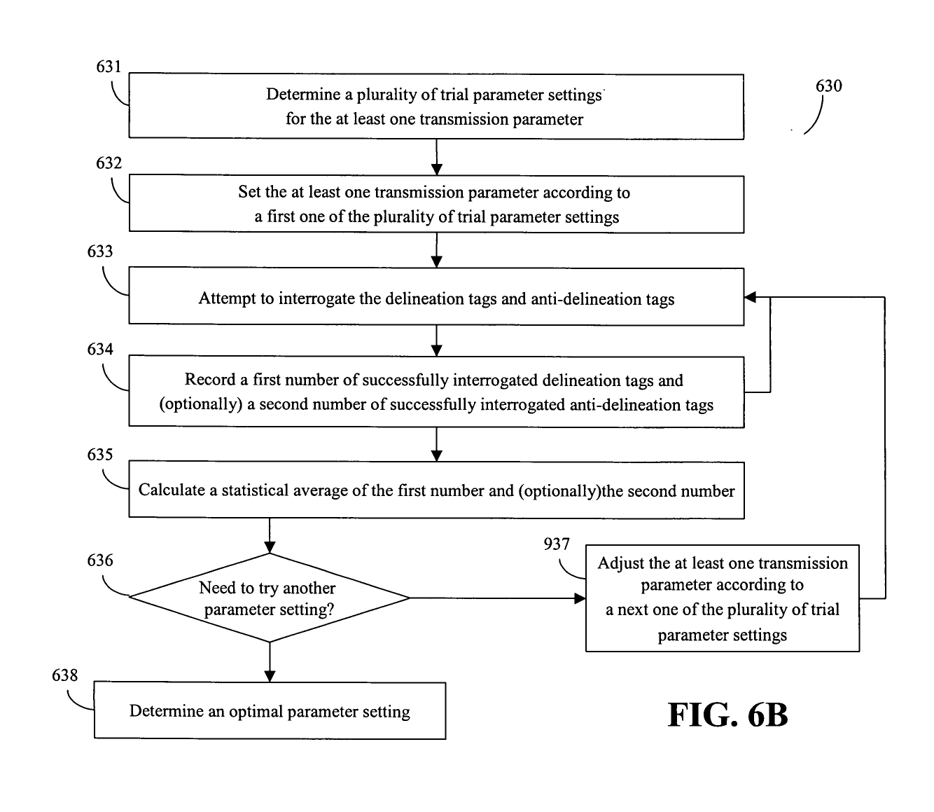

FIG. 6A illustrates a method 600 for controlling an area of successful interrogation by reader 110 according to one embodiment of the present invention. As shown in FIG. 6A, method 600 comprises step 610 in which the plurality of delineation RFID tags 120 are installed in the wanted region. The number of delineation tags 120 used can vary with the geometry of the wanted region and the precision desired. In one embodiment of the present invention, the number of delineation tags 120 is between 3 and 30. As tags are generally inexpensive, last indefinitely, and small in size and weight, they can be placed readily and the number of delineation tags employed has little impact on the cost or difficulty of installation. The number of delineation tags, however, can affect the length of a calibration step discussed below. Reader 110 can be informed of the unique identification number for each delineating tag so placed. The delineation tags may be staged along the boundary of the wanted region with equal distance from each other if the boundary is relatively smooth, or more tags are placed at or near vertices of the boundary. The delineation tags may also be placed uniformed throughout the wanted region or non-uniformly throughout the region with more tags occupying seemingly harder to reach areas in the wanted region.

Method 600 may also comprise an optional step 620 in which a plurality of anti-delineation tags are placed in or near the excluded region 103. These anti-delineation tags could simply be the same tags being used as delineation tags for a neighboring reader. The presence of the anti-delineation tags provides an additional input to the optimization algorithm, allowing reader 110 to optimally balance coverage of the wanted area with rejection of the excluded area. Again, the number of anti-delineation tags 120 used can vary with the geometry of the wanted region and the precision desired. In one embodiment of the present invention, the number of delineation tags 120 is generally greater than the number of anti-delineation tags. The anti-delineation tags may be placed along a side of the boundary of the excluded region that faces the wanted region. The anti-delineation tag may also be staged throughout the excluded region either uniformly or with emphasis placed on seemingly easy to reach areas by reader 110, or otherwise.

When the installation is completed, method 600 proceeds to perform a characterization method in step 630 in which reader 110 is activated and a calibration of its operation region or range of successful interrogation is performed to determine an optimal setting for the at least one transmission parameter associated with the reader. Afterwards, in step 640, the at least one transmission parameter associated with the reader is set according to the optimal setting.

The actual manner of characterization of transmission parameters depends somewhat on the implementation chosen. In one embodiment of the present invention, as shown in FIG. 6B, the characterization method in step 630 comprises step 631 in which a plurality of trial parameter settings for the at least one transmission parameter are determined. In the situation where the at least one transmission parameter includes only the transmitted power from reader 110, the plurality of trial parameter settings may comprise a plurality of discrete transmitted power settings running from a lowest possible transmitted power setting to a highest possible transmitted power setting, or vise versa. The step change from one transmitted power setting to a next transmitted power setting depends on the difference between the lowest possible transmitted power setting and the highest possible transmitted power setting, the size of the wanted area, the separation between the wanted area and the excluded are, or their combinations.

In the situation where the at one transmission parameter includes a selection of one of a plurality of antennas for transmitting the interrogation signal in addition to the transmitted power from the reader, the plurality of trial parameter settings may comprise a plurality of discrete transmitted power settings running from a lowest possible transmitted power setting to a highest possible transmitted power setting, or vise versa, for each antenna selection.

The phased array 500 provides more adjustable transmission parameters and thus more freedom to control the range of successful interrogation. In the situation of the phased array 500 being provided, the characterization step 630 may include a simple exhaustive search combined with power optimization to determine a parameter setting for optimized coverage. Thus, the plurality of parameter settings may include different combinations of possible values of the transmission parameters. The different combinations may be exhaustive or selective based on theoretical calculations and/or empirical data. In the more complex schemes in which continuous adjustment of phase and amplitude is possible, multivariate optimization schemes such as the method of steepest descents, Monte Carlo optimization, simplex optimization, or other optimization techniques may be used in stead of or in addition to the characterization method in step 630.

Still referring to FIG. 6B, the characterization method in step 630 further comprises step 632 in which the at least one transmission parameter associated with the reader is set according to a first one of the plurality of trial parameter settings. In the simplest case of the transmitted power being the at least one transmission parameter, the first one of the plurality of trial parameter settings may simply be the lowest possible transmitted power setting. The characterization method in step 630 further comprises step 633 in which an attempt to interrogate the delineation tags and optionally the anti-delineation tags are made and step 634 in which a first number or percentage of successfully interrogated delineation tags and optionally a second number or percentage of successfully interrogated anti-delineation tags are recorded.

Depending on the number of delineation or anti-delineation tags involved, the first number or percentage of successfully interrogated delineation or the second number of anti-delineation tags may need to be statistically averaged to ensure characterization accuracy. Therefore, the characterization method in step 630 may repeat the attempt and record steps 923 and 924 multiple times and calculate in step 925 a statistical average of the first number or percentage and optionally the second number or percentage based on the responses of the delineation tags and anti-delineation tags in the repeated attempts. The characterization method in step 630 proceeds to step 626 to determine if another parameter setting need to be tried. The determination may be based on whether all of the trial parameter settings have been tried or the responses of the delineation RFID tags and optionally the anti-delineation RFID tags for the trial parameter settings that have been tried so far. For example, in the situation of the transmitted power being the at least one transmission parameter, there is no need for an exhaustive search, the transmitted power can be ramped from a low setting to a certain setting at which a predetermined figure of merit calculated based on the first number or percentage and optionally the second number or percentage meets a predetermined criteria. The figure of merit may simply be the first number or percentage and the predetermined criteria be that the first number or percentage equals to or exceeds a predetermined number or percentage; or, the figure of merit may be, a weighted difference between the first number or percentage and the second number or percentage and the predetermined criteria be that the weighted difference equals to or exceeds a first predetermined value, i.e.:
A*first-number-or-percentage-B*second-number-or-percentage>=C1
   Where A is the weight on the first number and B is the weight on the second number, and C1 is the first predetermined value. A and B can be any positive value that are selected based on specific implementation.

In stead of ramping the transmitted power up, the transmitted power may also be ramped down from a high setting to a certain setting at which a predetermined figure of merit calculated based on the first number or percentage and optionally the second number or percentage meets a predetermined criteria. The figure of merit may simply be the second number or percentage and the predetermined criteria be that the second number or percentage is equal to or less than a predetermined number or percentage; or, the figure of merit may be a weighted difference between the first number or percentage and the second number or percentage and the predetermined criteria be that the weighted difference is near a second predetermined value, i.e.:
A*first-number-or-percentage-B*second-number-or-percentage˜C2
   Where C2 is the second pre-determined value.

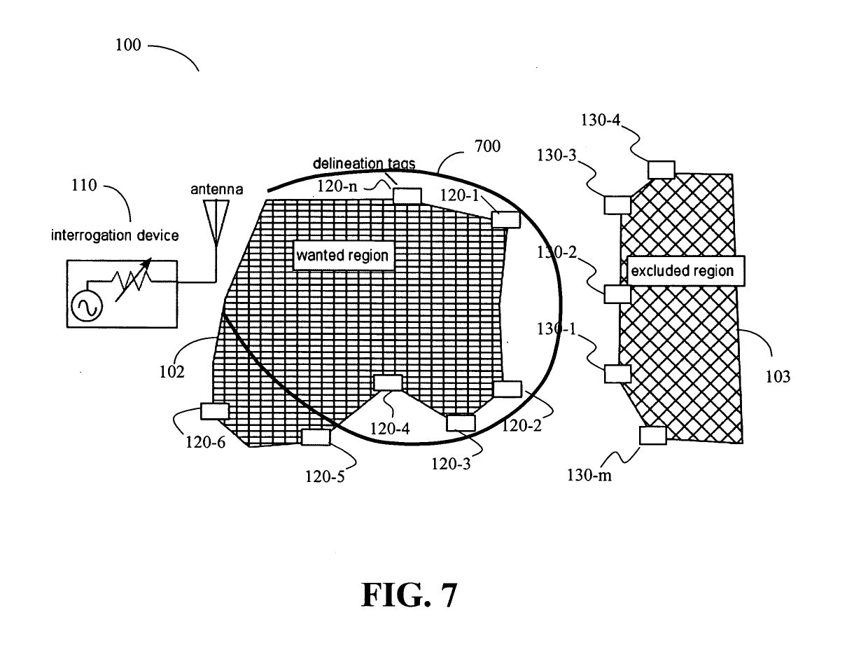

As shown in FIG. 7, by performing step 630, an optimal transmitted power can be selected so that the range of successful interrogation by reader 110 substantially overlaps with the wanted region 102.

In response to the determination that more parameter settings need to be tried, the characterization method in step 630 proceeds to step 927 in which the at least one transmission parameter is adjusted according to a next one of the plurality of trial parameter settings and steps 923 through 925 are repeated. Otherwise, the characterization method in step 630 proceeds to step 928 in which an optimal parameter setting is determined based on responses of the tags in the prior attempts to read the tags by the reader and a predetermined figure of merit as compared with a predetermined criteria as discussed above for each trial parameter setting. In the more complicated situations involving multiple antennas, as shown in FIG. 4 and FIG. 5, it is likely that multiple parameter settings will result in figures of merit that satisfy the predetermined criteria. When this happens, power optimization is performed to select an optimal parameter setting that has the least amount of transmitted power among the multiple parameter settings.

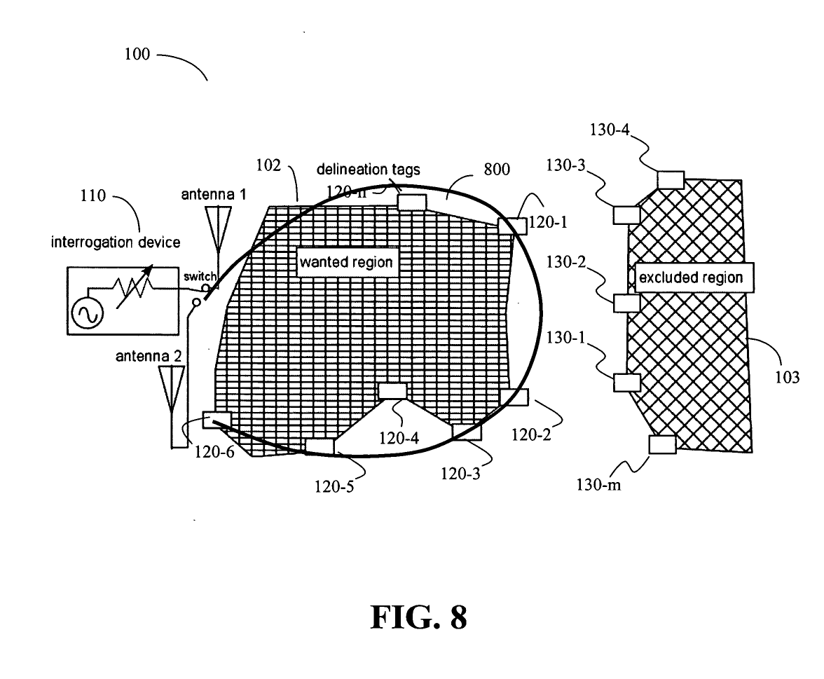

For example, when the at least one parameter includes a selection of one of a plurality of antennas for transmitting the interrogation signal in addition to the transmitted power, it is likely that either antenna can be selected to result in a figure of merit satisfying the predetermined criteria. FIG. 8 represents a situation in which antenna 2 is selected to transmit the transmit signal from reader 110 because less transmitted power is involved to result in a same or even better overlap between the range of successful interrogation 800 and the wanted area 102 than that shown in FIG. 7.

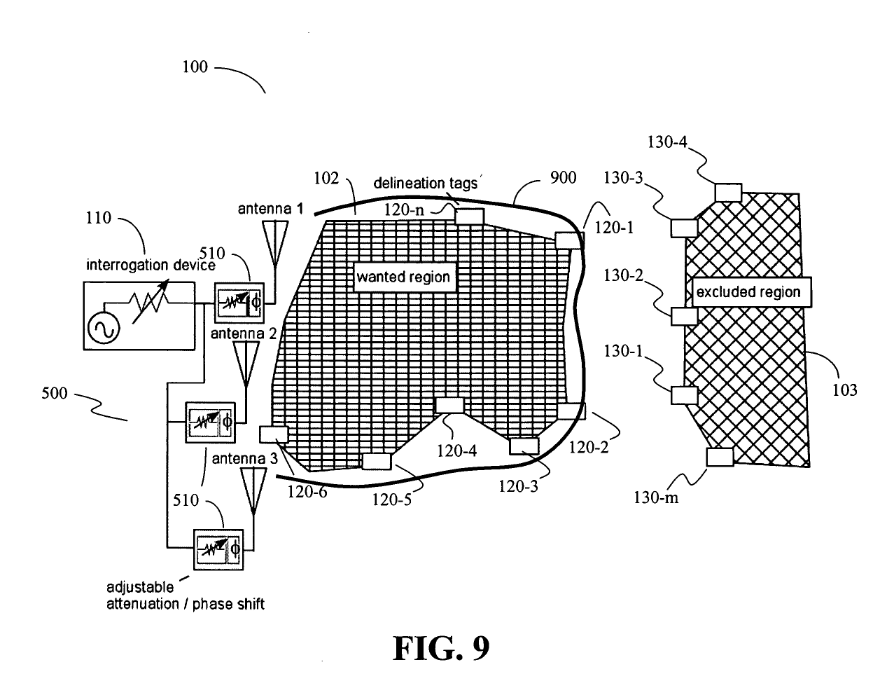

As shown in FIG. 9, the parameters associated with phased array 500 can be set at a particular setting to result in a range 900 of successful interrogation that overlaps with the wanted region 102 even more substantially than range 800 in FIG. 8. At this setting, all of the delineation RFID tags can be successfully identified while no anti-delineation RFID tag is read.

It must be noted that in order for an automated controller to arrive at an optimized arrangement of any such adaptive system, the number of input data must equal or exceed the number of degrees of freedom present in the adaptation. In this case the input data can be the probability of successfully reading each of the delineation tags. Transmitted power control constitutes one degree of adaptive freedom, requiring at least one delineation tag for adjustment. In the case where two or more transmitting antennas are also available, but only one antenna is in use at any given time, two degrees of freedom are available for adaptation and thus at least two delineating tags must be employed:; Similarly, for more complex implementations the number of delineating tags must be expanded to sufficiently constrain the optimization problem so as to enable the system to arrive at an optimum coverage solution.

It is well-known that propagation of radio signals in complex environments such as indoor areas or obstructed outdoor locations results in strong, essentially unpredictable, local variations in signal strength in time and space (commonly known as fading of the signal). Thus it is preferable to employ significantly more delineating tags than strictly required to equal the degrees of adaptive freedom, so that a statistically valid optimization procedure can be performed which will be relatively unaffected by such local fading or signal variations. Again, as noted above, the cost of acquisition and placement of RFID tags is modest, and with appropriate automation the labor involved in identifying the placed delineation tag to the interrogation device may also be readily minimized, so that the use of redundant delineation tags does not constitute a significant obstacle to the use of method 600.

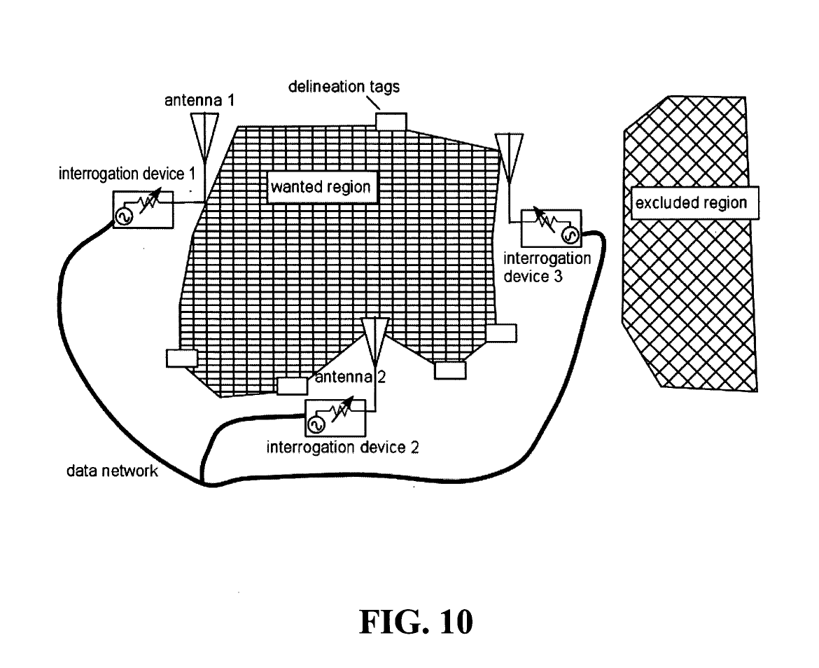

Additional receiving units may be used in addition to, or in place of, delineation tags to provide better overlap between the range of successful interrogation and the wanted region. In this case, the received signal strength at a given receiver can be communicated to the control unit to help in adjusting the coverage area; some calibration may be required to establish the correspondence between the received signal strength and the likelihood of tag detection in the corresponding location. As shown in FIG. 10, the receiving units 1010 could be interrogating devices themselves, and multiple interrogating devices are connected to a control unit such as the host computer 280 to form a data network. The multiple interrogating devices may use delineating tags as well as information collected from each other concerning their respective signal strengths, to jointly optimize the coverage of the wanted region and minimize coverage of the excluded region, by adjusting their output powers as well as optionally their relative phase or directivity.

The present invention has been described in terms of a number of embodiments, but this description is not meant to limit the scope of the invention. Numerous variations will be apparent to those with skill in the art, without departing from the spirit of the invention disclosed herein.

1. A system for reading an RFID tag in a defined region while reducing the possibility of reading other RFID tags outside the region, comprising:
an RFID reader at a fixed location in or near the region, the RFID reader capable of adjusting at least one associated transmission parameter; and
a plurality of delineation RFID tags each having a known and unique identification placed at specified locations in the region;
wherein the at least one transmission parameter associated with the reader is set according to responses from the delineation RFID tags to interrogation signals from the RFID reader and a predetermined figure of merit.

2. The system of claim 1 wherein the figure of merit is a statistical average.

3. The system of claim 1 wherein the at least one transmission parameter associated with the reader is set such that the reader is capable of successfully interrogating a number or percentage of the delineation RFID tags, the number or percentage being equal to or greater than a predetermined number or percentage.

4. The system of claim 1 wherein the at least one transmission parameter associated with the reader is set such that at least one delineation RFID tag is at or near a lowest threshold for successful interrogation by the reader.

5. The system of claim 1 further comprising a plurality of anti-delineation tags placed at specified locations near the region, wherein the at least one transmission parameter associated with the reader is set such that the reader is capable of successfully interrogating a first number or percentage of the delineation RFID tags and a second number or percentage of the anti-delineation RFID tags, a weighted difference between the first number or percentage and the second number or percentage being larger than a predetermined amount.

6. The system of claim 4 wherein the first number or percentage and the second number or percentage are statistically averaged based on repeated attempts to interrogate the delineation RFID tags and the anti-delineation RFID tags by the reader.

7. The system of claim 1 wherein the number of the delineation tags is between 3 and 30.

8. The system of claim 1 wherein the at least one transmission parameter comprises transmitted power from the reader.

9. The system of claim 1 wherein the at least one transmission parameter comprises angular distribution of transmitted power from the reader.

10. The system of claim 1 further comprising a plurality of antennas placed at different locations in or near the region, wherein the at least one transmission parameter comprises a selection of one of the plurality of antennas for transmitting interrogation signals from the reader.

11. The system of claim 1 further comprising an adaptive phased array coupled to the RFID reader, the adaptive phased array comprising a plurality of antennas placed at different locations in or near the region, each antenna being coupled to the RFID reader through one or both of a power attenuator configured to adjust transmitted power from the antenna and a phase shifter configured to adjust a phase of a transmitted signal from the antenna, wherein the at least one transmission parameter comprises one or both of the transmitted power from each antenna and the phase of the transmitted signal from each antenna.

12. The system of claim 1 wherein the delineation RFID tags are placed at the boundaries of the region.

13. A method for controlling a range of successful interrogation by an RFID reader associated with at least one adjustable transmission parameter, comprising:
placing a plurality of delineation RFID tags at specified locations in a wanted region;
for each of a plurality of trial parameter settings for the at least one transmission parameter, attempting to interrogate the plurality of delineation RFID tags using the RFID reader and recording responses from the delineation RFID tags;
determining an optimal transmission parameter setting for the reader based on a predetermined figure of merit calculated using the responses from the delineation RFID tags at each of the plurality of trial parameter settings and a pre-determined criteria; and;
setting at least one transmission parameter associated with the RFID reader according to the optimal transmission parameter setting.

14. The method of claim 13 wherein the attempting step comprises repeatedly attempting to interrogate the plurality of delineation RFID tags using the RFID reader at each of the plurality of trial parameter settings and the figure of merit represents a statistical average.

15. The method of claim 13 wherein the at least one transmission parameter comprises transmitted power from the RFID reader and the determining step comprises finding a transmitted power setting at which the RFID reader is capable of successfully interrogating a number or percentage of the delineation RFID tags, the number of percentage being equal to or greater than a predetermined number or percentage.

16. The method of claim 13 wherein the at least one transmission parameter comprises transmitted power from the RFID reader and a selection of one of a plurality of antennas for transmitting interrogation signals from the RFID reader, and wherein the determining step comprises finding a best antenna for connection with the RFID reader based on a number of successfully interrogated delineation RFID tags by the reader at each of a plurality of transmitted power settings and for each selection of the plurality of antennas.

17. The method of claim 13 wherein the RFID reader is associated with an adaptive phased array coupled to the RFID reader, the adaptive phased array comprising a plurality of antennas placed at different locations in or near the region, each antenna being coupled to the RFID reader through one or both of a power attenuator for adjusting transmitted power from the antenna and a phase shifter for controlling a phase of a transmitted signal from the antenna, and wherein the at least one transmission parameter comprises one or both of the transmitted power from each antenna and the phase of the transmitted signal from each antenna.

18. The method of claim 17 wherein the plurality of trial parameter settings are selected according to a method selected from the group consisting of methods of steepest descents, Monte Carlo optimization, and simplex optimization.

19. The method of claim 14 further comprising:
placing a plurality of anti-delineation tags at specified locations near the wanted region; and
for each of the plurality of trial parameter settings, attempting to interrogate the plurality of anti-delineation RFID tags using the RFID reader and recording responses from the anti-delineation RFID tags to the interrogation signals from the reader;
wherein the determining step comprises determining an optimal transmission parameter setting for the RFID reader based on the responses from the delineation RFID tags and the anti-delineation RFID tags and the predetermined figure of merit.

20. The method of claim 19 wherein the predetermined figure of merit is a weighted difference between a number or percentage of successfully interrogated delineation RFID tags and a number or percentage of successfully interrogated anti-delineation RFID tags by the reader at each of the plurality of trial parameter settings, the weighted difference being evaluated with respect to the predetermined criteria.

21. The method of claim 14 wherein the placing step comprises placing a number of 3 to 30 delineation RFID tags along a boundary of the wanted region.

22. The method of claim 13 wherein the determining step comprises power optimization.
